(19) United States
(12) Patent Application Publication
(10) Pub. No.: US 2012/0123791 A1
(43) Pub. Date: May 17, 2012

(54) Personalized Coordinated Perinatal Care System

(76) Inventor: Steven Earl Calvin, Minneapolis, MN (US)

(21) Appl. No.: 12/965,863

(22) Filed: Dec. 11, 2010

Related U.S. Application Data
(60) Provisional application No. 61/381,431, filed on Sep. 9, 2010.
(60) Provisional application No. 61/413,427, filed on Nov. 13, 2010.

(51) Int. Cl. G06Q 50/00; G06Q 10/00

(52) U.S. Cl. 705/2

(57) ABSTRACT

A system to provide personalized coordinated perinatal care for a woman and her baby. It includes an electronic database on an internet-connected server comprising a comprehensive list of perinatal care services and at least a first completed detailed questionnaire about a woman's personal situation. A comprehensive perinatal risk-scoring and selection algorithm in electronic communication with each questionnaire can both assign a perinatal care risk category to the questionnaire and assemble a comprehensive list of services based on the woman's personal situation. Also, an electronic database contains a list of contracted vendors who have agreed to perform each perinatal care service. Finally, a matching algorithm in communication with the databases and the algorithm is configured to match the comprehensive list of services with the contracted vendors that have agreed to perform them to generate at least one bundled list that most closely matches the needed services with the woman's personal situation.

### CROSS REFERENCE TO RELATED APPLICATIONS

This application claims the benefit of PPA App. No. 61/381,431 filed Sep. 9, 2010 and PPA App. No. 61/413,427 filed Nov. 13, 2010 by Steven Earl Calvin.

### FIELD OF THE INVENTION

This invention relates to a system, method, and apparatus to provide a comprehensive bundled package of pregnancy care for women driven by the woman's individual obstetric situation and her care preferences.

### BACKGROUND OF THE INVENTION

There is a need for a comprehensive bundled package of coordinated perinatal care services for individual mothers and babies that is driven by each individual obstetric situation and maternal care preferences.

Pregnancy is a unique health care situation. This time-limited episode in a woman's life is usually a normal physiologic event. Yet some women have pregnancies that become medically complicated for maternal or fetal reasons. The challenge is to recognize and treat the mothers and fetuses with true complications without performing unwarranted tests and medical or surgical interventions on mothers and babies with normal pregnancies.

The present perinatal care system in the United States is largely an uncoordinated collection of facilities, providers, and payers. Fees are charged for individual services by facilities and providers that often perform tests and medical or surgical interventions that may not be justified by clinical efficacy research or patient preferences. Payers attempt to control costs by restrictions based on population averages rather than individual patient situations. Because the various parties are uncoordinated they are driven by independent motivations. Facilities are motivated to use their space, equipment, and personnel as much as possible to increase revenue and decrease perceived liability risks. Similarly, providers are motivated to increase revenue and decrease the perceived risk of malpractice liability. Payers are necessarily motivated to maintain financial margins but have less incentive to control premium costs. Since the overall efforts are uncoordinated, there is little opportunity to control overall costs. In addition, since current pregnancy care efforts are often driven by forces unrelated to the pregnant mother, there is little motivation to learn her obstetric situation or preferences in a manner that would allow for perinatal care that individually satisfies her while reducing unnecessary testing and avoiding unnecessary medical or surgical interventions.

Recent efforts have tried to standardize perinatal care through the use of quality assessment and pay for performance programs set up by government, insurers, and hospitals. These efforts are focused on the perception that overall population testing and intervention rates can be influenced by such programs. However, these efforts do not consider the individual pregnant woman's situation or her preferences. Thus, unnecessary tests and procedures are still common because of policy and legal considerations.

As a result, there is still a need for a comprehensive bundled package of personalized coordinated perinatal care services for a woman and her baby driven by her individual pregnancy situation and preferences.

### SUMMARY OF THE INVENTION

I have invented a system able to provide personalized, coordinated, perinatal care for a woman and her baby that includes four elements. First it includes an electronic database on an internet-connected server comprising a comprehensive list of perinatal care services and data from at least a first completed questionnaire about a woman's personal situation related to her pregnancy. This questionnaire addresses her obstetric history, current life style, pregnancy care preferences, and medical issues that may affect her pregnancy. Second, a comprehensive perinatal risk-scoring and selection algorithm in electronic communication with the database is configured to assign a perinatal care risk category to the completed questionnaire and assemble a comprehensive list of services based on the woman's personal situation. Third, an electronic database is included that contains a list of contracted vendors who have agreed to perform the perinatal care services. Fourth, a first matching algorithm is configured to match the comprehensive list of recommended services with the contracted vendors that have agreed to perform them to generate at least one bundled list containing both the comprehensive services and contracted vendors able to perform the services.

I have also invented a method for providing a pregnant woman with personalized coordinated perinatal care for the woman and her baby that includes six steps. The first step is compiling a comprehensive list of perinatal care services and a list of contracted vendors that perform the perinatal care services within geographical regions. The second step is providing a detailed questionnaire about a woman's personal situation regarding her pregnancy comprising her obstetric history, current life style, pregnancy care preferences, and medical issues that may affect her pregnancy. The third step is receiving the completed questionnaire from the woman. The fourth step is applying a comprehensive perinatal risk-scoring algorithm to the completed questionnaire to determine at least an initial risk category for her pregnancy and to assemble at least one comprehensive list of services based on the woman's personal situation. The fifth step is assembling at least one bundled list of perinatal care services most closely matching her personal situation regarding her pregnancy that comprises the comprehensive list and the contracted vendors able to perform the needed services. The sixth step is providing the woman with at least one bundled list.

In addition, I have invented an apparatus for providing personalized coordinated perinatal care for a pregnant woman and her baby that includes four elements. The first element of the apparatus is a server in communication with the internet and having a database with a comprehensive list of perinatal care services and at least one completed questionnaire about a woman's personal situation comprising her obstetric history, current life style, pregnancy care preferences, and medical issues that may affect her pregnancy. The second element is a server having a risk-scoring algorithm in communication with the database and configured to both determine a pregnancy risk category and assemble a comprehensive list of services based on the woman's personal situation. The third is a server having a database comprising a list of contracted vendors associated with a geographical region. The fourth element of the apparatus is a server having a matching algorithm in communication with data from the woman's completed questionnaire, the recommended list of services, and the list of contracted vendors. This algorithm is configured to match the comprehensive list of services that most closely match the woman's personal situation with the contracted vendors that have agreed to perform them to generate at least one bundled list containing both the services and the contracted vendors able to perform the services. More than one server may be the same server.

My invention satisfies a longstanding but previously unsatisfied desire in the United States to provide high-quality perinatal care services that are most appropriate for an individual woman without unnecessary testing and medical or surgical interventions. The various aspects of my invention differ from current perinatal care systems in that mine are dynamically-coordinated and all elements are driven by knowledge of both the personal medical situation and the pregnancy care preferences of each woman. Addressing both the individual medical reality and pregnancy care preferences allows care services to be efficiently matched with individual pregnant women. All other systems are either uncoordinated or are rigid and are driven by institutional policy and perceived liability risks. The existing systems that do attempt coordination are largely driven by forces other than the woman's personal preferences. Thus, the aspects of my invention offer increased personal satisfaction to women who use them while still meeting their medical needs. In addition, aspects of my invention offer the possibility of lowering the overall cost of pregnancy care as well as better controlling future increases in cost.

As used herein:

“Contracted vendors” mean suppliers of perinatal services such as, for example, facilities, providers, and payers that are under contract to provide services driven by a pregnant woman's personal situation.

“Coordinator” means a business entity that brings the facilities, providers, and payers together to provide seamless pregnancy care for a mother and her baby driven by her personal situation.

“Facilities” mean suppliers of structures and equipment such as, for example, hospitals, birthing centers within hospitals, and midwife-directed, freestanding birth centers.

“High Risk Insurer” means a business entity able to contractually offer insurance for the cost of high-risk service occurrences during perinatal care that were not foreseen during verification of the initial risk score assessment of low risk.

“High risk pregnancy” means a pregnant woman having one or more risk factors such as, for example, obesity as defined by a Body Mass Index (BMI) of greater than twenty-nine (29) kilograms per meter squared (kg/M²), insulin dependent diabetes, maternal heart or lung disease, hypertension requiring medication, autoimmune disease, multiple gestation (i.e., at least twins), substance abuse, mental illness, HIV+, previous preterm birth at less than thirty-six (36) weeks, or fetal anomalies. Pregnant women who are otherwise normal may still be considered low risk even if lethal anomalies are present but the patient chooses perinatal hospice care.

“Low risk pregnancy” means having at least the following personal situation: a singleton pregnancy, at least fifteen (15) years of age and less than forty-five (45) years of age, care must be initiated by twenty (20) weeks, the mother must be a candidate for a vaginal delivery (either first pregnancy, previous vaginal delivery, or a single previous cesarean section who is a candidate for a trial of labor after cesarean section), if a smoker she must be committed to smoking cessation, and her baseline medical history and examination must be normal.

“Payer” means the entity that is responsible for paying for the cost of perinatal care services including, for example, employers, pregnant women, and government aid agencies.

“Perinatal care” means the comprehensive obstetrical care of a woman and her baby from the diagnosis of pregnancy to the immediate newborn period of the baby and up to six (6) weeks after birth for the mother.

“Providers” mean individuals or groups of individuals that provide perinatal services to women during and after pregnancy such as, for example, medical, nutritional, and psychological care.

“Woman's personal situation” means factors that may affect an individual woman's pregnancy such as, for example, her obstetric history, current life style, pregnancy care preferences, and medical issues that may affect her pregnancy.

### BRIEF DESCRIPTION OF THE DRAWINGS

One or more features of embodiments of the invention are described in the accompanying drawings. The drawings are briefly described below.

FIG. 1 is a schematic illustration of the coordinated nature of the invention (A) compared with the present state of perinatal care in the United States (B).

FIG. 2 is a block diagram of an embodiment of the services offered to the mother during the new pregnancy care phase of the perinatal care process of the invention.

FIG. 3 is a block diagram of an embodiment of the services offered to the mother during the pre-natal care phase of the perinatal care process of the invention.

FIG. 4 is a block diagram of an embodiment of the services offered to the mother during the birth preparation and delivery phase of the perinatal care process of the invention.

FIG. 5 is a block diagram of an embodiment of the services offered to the mother during the post-partum and baby care phase of the perinatal care process of the invention.

FIG. 6 is a block diagram illustrating the main elements of the system of the invention.

FIG. 7 is a block diagram showing the information provided by a pregnant woman in a questionnaire.

FIG. 8 is a sample embodiment of a questionnaire for a pregnant woman about her preferences relating to perinatal care.

FIG. 9 is a sample embodiment of a questionnaire for a contracted perinatal care vendor.

FIG. 10 is a block diagram of the components of the bundled perinatal services of an embodiment of the invention.

FIG. 11 is a block diagram of an embodiment of the new-pregnancy care phase of the perinatal care process of the invention.

FIG. 12 is a block diagram of an embodiment of the pre-natal care phase of the perinatal care process of the invention.

FIG. 13 is a block diagram of an embodiment of the birth preparation and delivery care phase of the perinatal care process of the invention.

FIG. 14 is a block diagram of an embodiment of the post-partum and baby care phase of the perinatal care process of the invention.

### DETAILED DESCRIPTION OF SOME EMBODIMENTS OF THE INVENTION

Present perinatal care systems in the United States are driven by generalized health care policies, legal landscapes, and profit objectives rather than a woman's personal situation. These systems comprise at least three elements, e.g., facilities, providers, and payers that typically act in an uncoordinated manner where each generally is motivated by conflicting drives and incentives. Even when the elements act in a coordinated manner, the coordination is based on generalized health policies, the legal landscape, and profit motives rather than a woman's individual situation. A woman's personal situation is defined as her medical record, her current life style, her preferences relating to the perinatal care experience, and the specific health issues affecting her pregnancy. All of these systems tend to be expensive, inefficient, and impersonal. Thus, there is a need for a perinatal care system that coordinates the facilities, providers, and payers that is driven to satisfy the individual situation of the woman.

The current care system is further complicated because the services of each vendor are most often fee for service rather than combined into a single total fee for the entire perinatal care process. Because a single fee is not offered, vendors have little incentive to control total costs. Providers often charge more if complications arise. Both facilities and providers may select unnecessary tests for reasons other than the mother's health and may elect to perform unnecessary medical or surgical interventions. Payers are typically concerned with maintaining profits rather than controlling premiums. Therefore, vendors do little to control total costs internally.

In addition, complications in care services may arise when at least some of the services are changed during pregnancy. At times a woman may want to or need to change her perinatal care services. Sometimes her medical, current life style, or obstetrical health issues may change and therefore require other services. Women who are initially low risk may become high risk. Other times the change may be motivated by personal preference or an economic change such as loss of work by her or her husband. During these times changing services under current care systems is often difficult, time consuming, and expensive. Thus, there is also a need for a coordinated perinatal care system that both is driven to satisfy the individual situation of the woman and is offered at a single fee for the total care process. Such systems would be substantially seamless to the woman during any necessary process change.

In this document pregnancy is categorized as either high risk or low risk. Both categories require comprehensive perinatal services. Depending on the definitions used up seventy-five (75) percent of pregnancies in the United States may be considered low risk.

Pregnancies that are high risk typically require more specialized services and the services are highly varied. These high-risk pregnancies often require expensive testing and procedures in an effort to avoid adverse outcomes. A high-risk pregnancy is one where a pregnant woman has one or more risk factors that would require significant additional perinatal care for the health of the woman and the baby or babies. These factors include, for example, obesity as defined by a Body Mass Index (BMI) of greater than twenty-nine (29) kilograms per meter squared (kg/M²), insulin dependency, diabetes, maternal heart or lung disease, hypertension requiring medication, autoimmune disease, multiple gestation, i.e., at least twins, substance abuse, mental illness, HIV+, previous preterm birth of less than thirty-six (36) weeks, and fetal anomalies. Pregnant women who are otherwise normal may be considered low risk even if lethal anomalies are present but the patient chooses perinatal hospice care. It is presently difficult to set a packaged fee at the outset for a high-risk pregnancy due to the extensive number of possible procedures and the uncertainty of which procedures will be necessary.

Pregnancies that are low risk typically require more routine services that do lend themselves to an easy determination of a total cost at the outset. A low-risk pregnancy is one that does not signal a significant probability of serious complications as a result of an initial medical history and examination. More specifically, a low-risk pregnancy is one where a woman has at least the following personal situation. The pregnancy must be a singleton pregnancy, in a woman between the ages of fifteen (15) and forty-five (45), care must be initiated by twenty (20) weeks, and the mother must be a candidate for a vaginal delivery (e.g. either first pregnancy, previous vaginal delivery, or a single previous cesarean section who is a candidate for a trial of labor after cesarean section). Also, the woman must be committed to smoking cessation if she is a smoker. In addition, she must have a baseline medical history and examination that is normal.

Women in a low-risk category have significantly less need for routine testing and medical or surgical interventions than are commonly performed on low-risk women in current perinatal care systems. However, these unnecessary tests and interventions are common today because they are largely based on generalized policies derived for large populations or on policies driven by the fear of isolated adverse legal outcomes. In addition, the occurrence of these unnecessary tests and interventions are magnified by the uncoordinated nature of the vendors with different motivations. Facilities are concerned with the maximum use of space and equipment, providers are fee based with little internal concern for the total perinatal costs and great concern for limiting legal liability, and payers are concerned with costs and profits. Costs typically vary from one geographical region to another. Thus, there is also a need for a coordinated perinatal care package of services driven to satisfy the individual situation of the woman that is available for a single fee for the entire process that applies to all low-risk pregnancies within a geographical area.

In some situations, a pregnancy initially categorized as low risk may become high risk. Changes in a woman's personal situation may occur, such as, for example, preeclampsia, preterm labor, preterm rupture of membranes, and fetal anomalies or illness. Thus, any packaged fee for low-risk pregnancies needs to address the possibility of such occurrences.

My invention provides comprehensive and coordinated obstetrical care based on the woman's personal situation. To meet her unique needs the most appropriate provider, in the proper setting, provides each mother the right level of care. My invention is a virtual obstetrical care organization that contracts with providers and facilities and then utilizes these partners to coordinate care, ensuring the best care for each woman's unique pregnancy. This model of care is innovative because it is driven by the woman's personal situation instead of other factors discussed above.

My invention also provides the care for a single fee to women having a pregnancy categorized as low risk; a risk shared by a significant majority of women in the United States. For these women, my invention does not require expensive overhead in facilities and providers. It also provides cost savings and predictability since the care is paid for as a comprehensive bundled payment. The comprehensive bundled payment includes the cost of insuring for clearly defined rare complications. This is a great improvement over the current fragmented system of fee for service care that increases cost and the use of unnecessary medical interventions.

My invention utilizes an evidence-based risk assessment and care selection algorithm to create an individualized bundle of pregnancy care services tailored to the woman's personal situation. In some embodiments the bundle is frequently updated during the pregnancy. The output of this risk-scoring and selection algorithm becomes a part of each woman's personal pregnancy health record that is stored on the database as a secure web-based record. The record and the algorithm provide each pregnant woman and her pregnancy care provider the information needed to make the best decisions for mother and baby during prenatal care, birth, and the post delivery period.

My invention is designed to maximize the likelihood that pregnancy will be an exciting but normal physiologic life event that it is in the majority of women. These normal women will be empowered to take control of their pregnancy and birth in an environment of support and safety. The women who desire non-medicalized care in a free standing birth center with midwives will also have this option available to them.

Other normal risk mothers may choose to have their prenatal and birth care with obstetrics or family practice physicians. These births will occur in traditional hospital settings. If complications develop later, a seamless supportive consultative safety net will be available to all women.

The portal and coordinating method of this care is the website which includes secure access to a personal situation questionnaire and resulting bundle of services. In some embodiments, the website will also provide a secure messaging and scheduling tool that links to educational resources. Women who do not have Internet access at home will have access to these services by other direct means such as through a library computer or a computer available in such places as, for example, the site of a facility or provider.

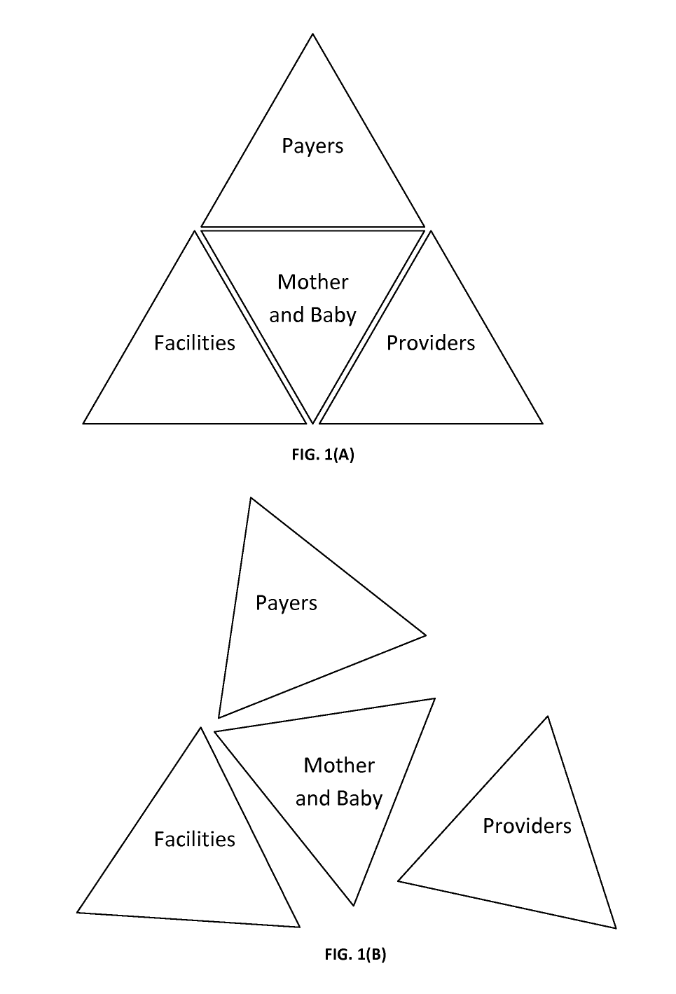

Different embodiments of my invention satisfy the needs stated above. Briefly, my invention involves personalized coordinated perinatal care that is driven by an initial assessment of a woman's personal situation during pregnancy. In some embodiments, the assessment is ongoing. As used herein, perinatal care is the comprehensive obstetrical care of a woman and her baby from the diagnosis of pregnancy to the immediate newborn period of the baby and up to six (6) weeks after birth for the mother. The care includes four components, i.e., facilities, providers, payers, and the mother and baby. My invention provides perinatal care that is coordinated with the mother and baby driving the other components. FIG. 1 is a schematic illustration of the coordinated nature of the invention (A) compared with the present state of perinatal care in the United States (B). As illustrated in (A), the components of perinatal care are organized, driven, and motivated around the mother and baby. As illustrated in (B), the current system components are not connected and are left to be driven by varied and conflicting motivations in the provision of pregnancy care.

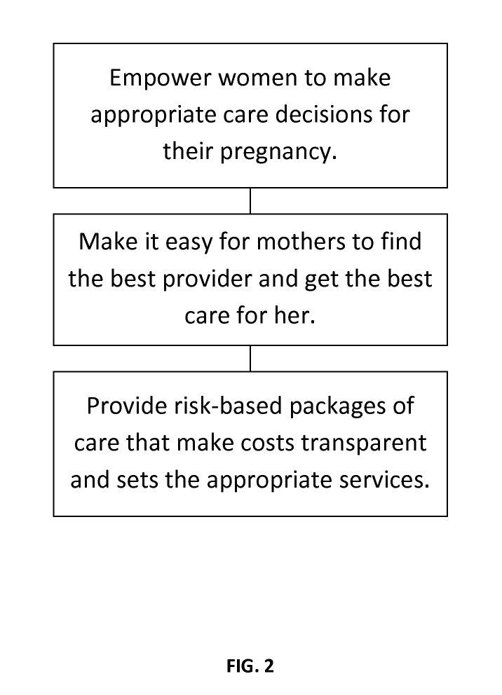

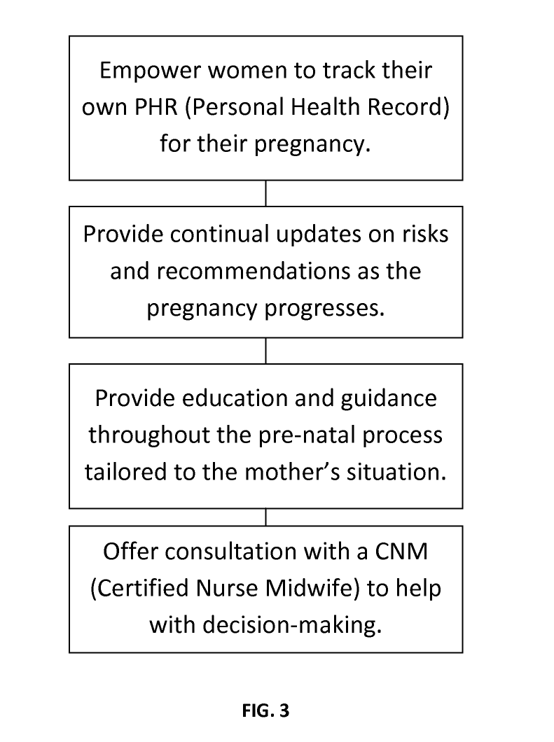

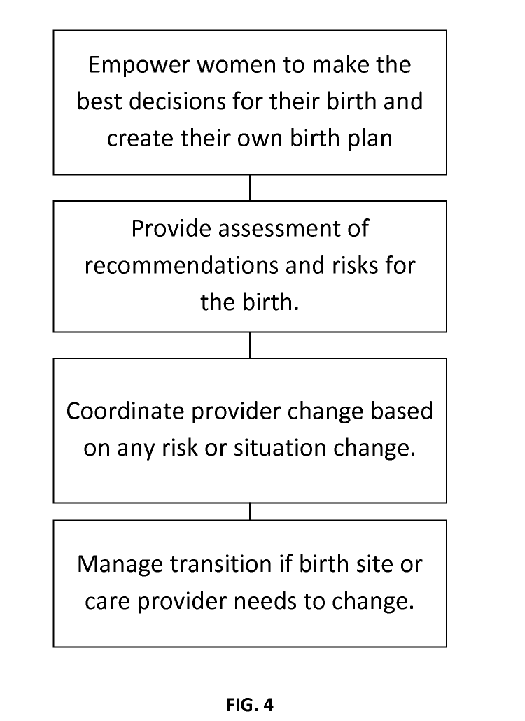

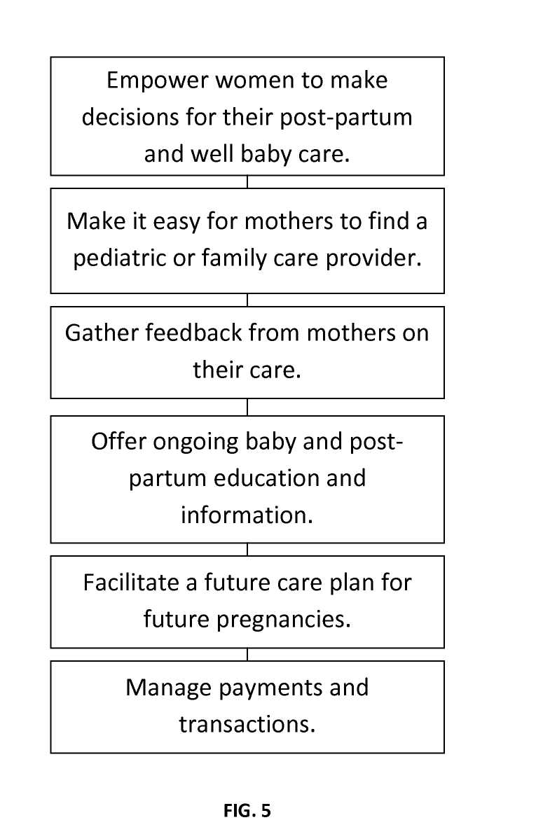

FIGS. 2-5 are block diagrams that illustrate the services to the mother that the care coordination of my invention offers. The services occur during all four stages of pregnancy. FIG. 2 depicts services during the new pregnancy care phase and FIG. 3 during the pre-natal care phase. FIG. 4 illustrates services during the birth preparation and delivery phase and FIG. 5 during the post-partum and baby care phase. As seen, these services are focused on the woman's personal situation.

My invention has three aspects: a system, a method, and an apparatus. Each will now be described in further detail.

### System

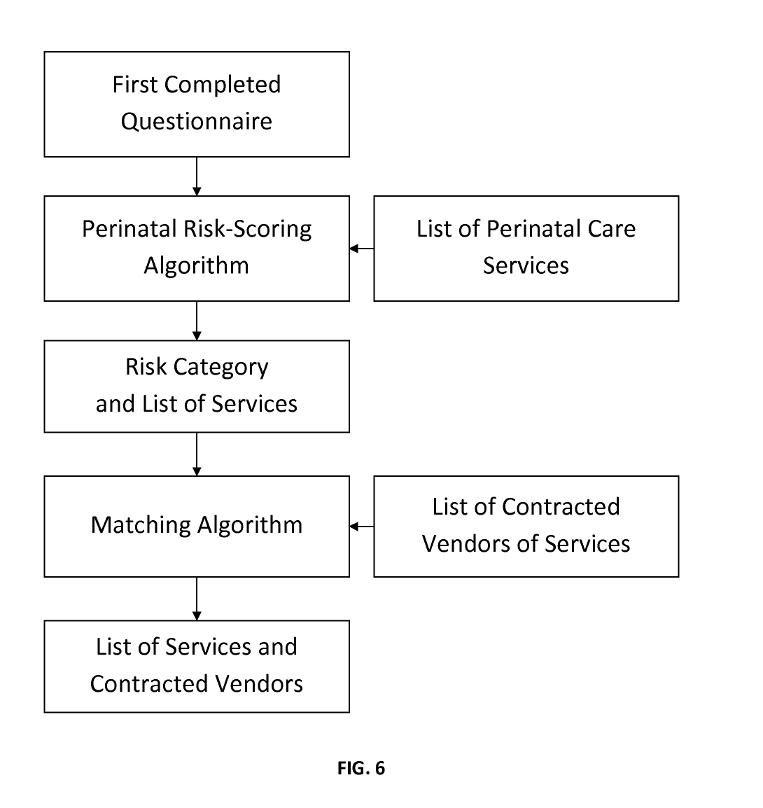

In its broadest sense, the system aspect of my invention includes four elements. The first is a database comprising perinatal care service information and information provided by a pregnant woman. The second is a risk scoring and selection algorithm that evaluates her pregnancy risk. The third is a database comprising contracted vendor information. The fourth is a matching algorithm that results in a bundled list of services for the woman. FIG. 6 is a block diagram illustrating the main elements of the system of the invention.

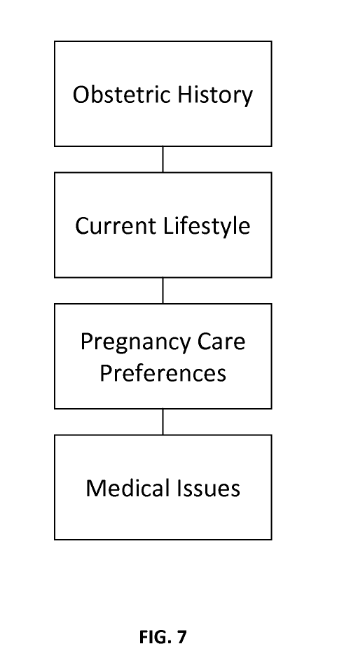

The first element is a database comprising perinatal care service information and information provided by a pregnant woman. Specifically, the database is an electronic database that is on an internet-connected server. The database comprises a comprehensive list of perinatal care services. This list is generally known to specialists in the pregnancy care medical arts. The database also includes data from at least a first completed detailed questionnaire about a woman's personal situation related to her pregnancy. This questionnaire addresses her obstetric history, current life style, pregnancy care preferences, and medical issues that may affect her pregnancy. FIG. 7 is a block diagram showing the four factors that are included in the questionnaire that illustrates the woman's personal situation.

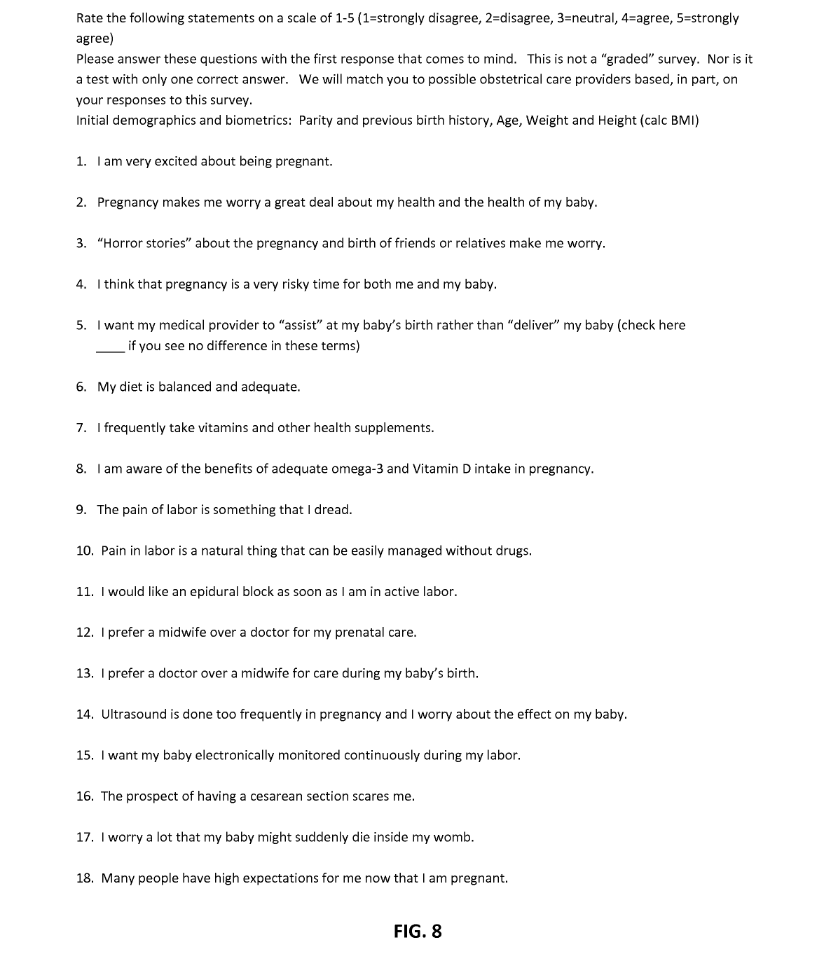

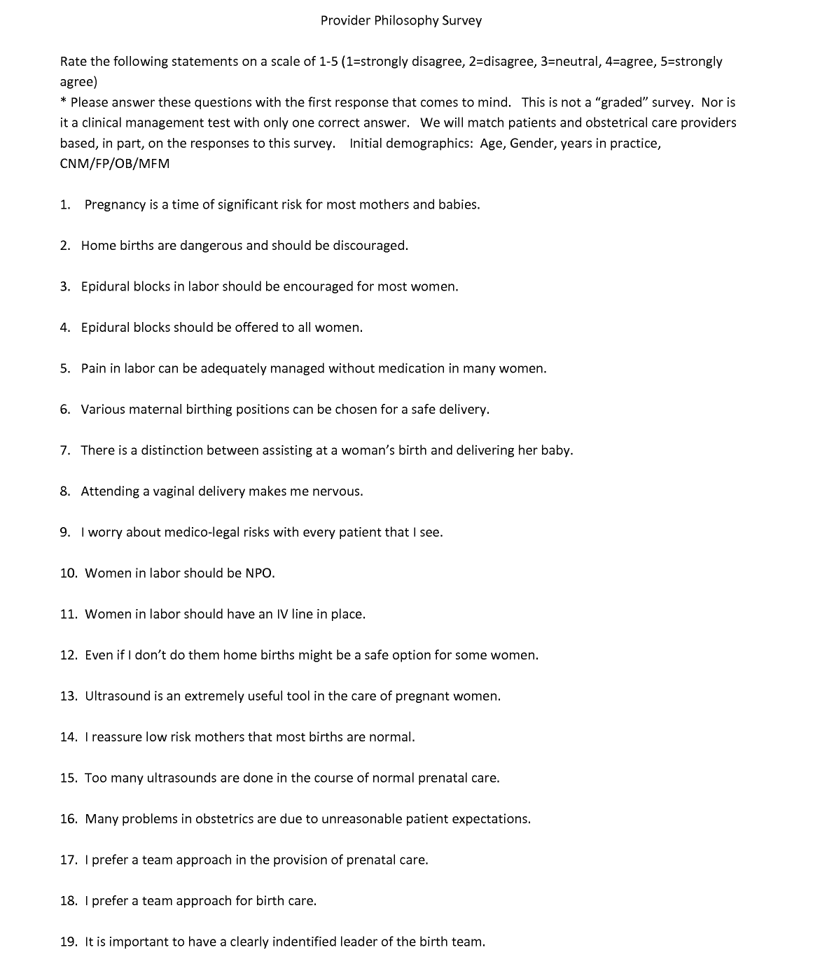

The personal situation information is used to tailor the perinatal care bundle to the woman's personal situation. The obstetric history and medical issues that may affect her pregnancy are generally factors in present pregnancy care systems although generally not principal drivers that determine tests, interventions, and other procedures. Data about the woman's current lifestyle is also sometimes sought but not as a factor that determines pregnancy care in current systems. In some embodiments of my invention, the current lifestyle also includes the woman's nutritional status. In current pregnancy care systems, the woman's personal pregnancy care preferences are not intentionally used to plan her care. Most women have a strong desire to be intimately involved in decisions regarding their pregnancy care. FIG. 8 is an embodiment of the questionnaire that focuses on the preferences of the pregnant woman. Other forms and content are possible as long as they obtain the preferences of the woman during pregnancy.

The second element is a risk-scoring and selection algorithm that evaluates her pregnancy risk. This algorithm is in electronic communication with data from each questionnaire. It is configured to assign a perinatal care risk category to the pregnancy. In some embodiments the pregnancy risk categories are low risk and high risk as previously defined. In other embodiments, the high-risk category may be further broken down in to one or more categories that designate a range of risk within the high-risk category. The algorithm is also in electronic communication with the list of perinatal care services and is configured to assemble a comprehensive list of recommended pregnancy care services based on the woman's personal situation.

The third element is a database comprising contracted vendor information. Specifically, the database is an electronic database that is on an internet-connected server. The database comprises a comprehensive list of contracted vendors who have at least agreed under contract to perform the above perinatal care services assembled. In some embodiments, the vendors have agreed under contract to perform the services for a single fee during the span of a pregnancy.

Vendors are at least providers of pregnancy care services. Providers are individuals that provide perinatal services to women during and after pregnancy such as, for example, medical, nutritional, and psychological services. In some embodiments vendors are also facilities. Facilities are suppliers of structures and equipment such as, for example, hospitals, birthing centers, and midwife centers. In some embodiments, vendors are also payers. Payers are the entities that are responsible for paying for the cost of perinatal care services including, for example, employers, pregnant women, and state and federal aid agencies.

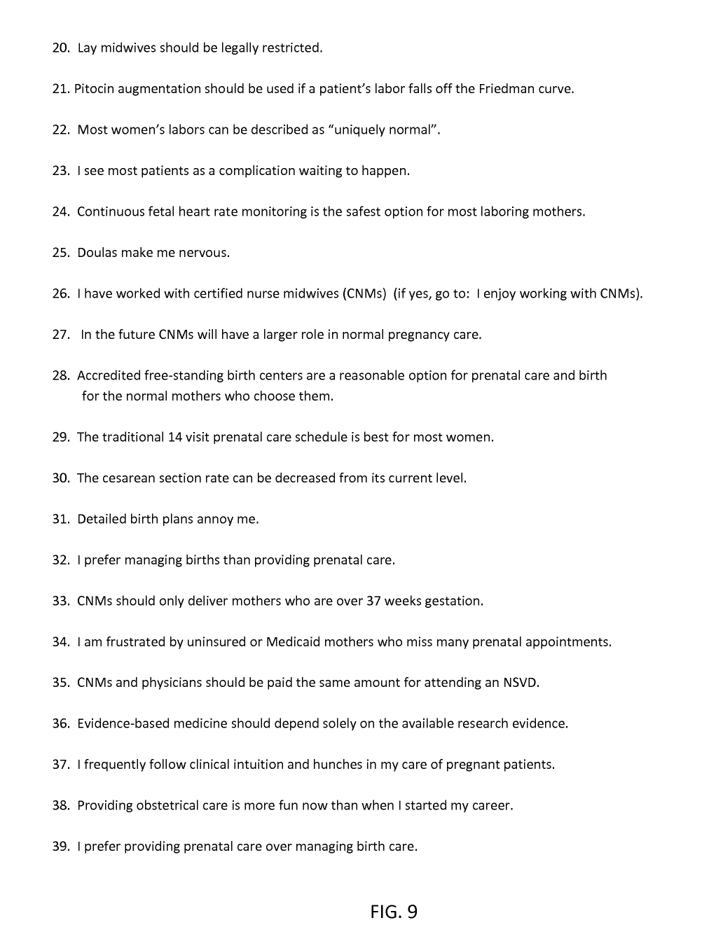

In some embodiments, the database also contains information about the contracted vendor pregnancy care preferences. Some contracted vendors provide midwife-assisted pregnancy. Others are open to natural childbirth without the assistance of such options as, for example, an epidural block. Still others prefer to provide birth and pregnancy services in facilities able to offer all methods of obstetric pain relief. These provider preferences may be contrary to those of the mother. Contracted vendors, particularly providers, supply completed surveys that list their preferences for providing pregnancy care. This data can then be a factor in the matching of a vendor with a mother's personal situation. FIG. 9 is a sample embodiment of a questionnaire for a contracted perinatal care vendor.

The fourth element is a matching algorithm that results in a bundled list of services for the woman. This matching algorithm is in electronic communication with both data from the woman and the vendors and results from the risk-scoring and selection algorithm. It is configured to match the comprehensive list of recommend services that most closely match the woman's personal situation with the contracted vendors that have agreed to perform those services. The algorithm is also configured to generate at least one bundled list containing both the comprehensive services and contracted vendors able to perform the services. In some embodiments, the vendors have listed the geographical area that they service and the bundle includes vendors geographically accessible to the woman.

In some embodiments the woman may complete the questionnaire more than once. During her pregnancy, a woman may want to obtain her perinatal care risk category if something significant has occurred that she believes would change the risk category or bundled list of services. She also may want to take the pregnancy care questionnaire periodically during pregnancy to monitor any changes in the bundled list of recommended services. Similarly, another, such as a provider currently providing some of her care services, may also want to monitor her care needs by having her complete the questionnaire periodically during her pregnancy to determine necessary changes in the nature of the bundled care being provided.

Bundled list of services for woman having an initial pregnancy category of low risk may appear in at least two types, those including care directed by a medical doctor and those including care directed by a midwife. Other types may be available if they represent bundles with significantly different services or fees. Additional bundles may be provided for each type where more than one midwife or medical doctor satisfy the woman's personal situation. In addition, bundles that include one type of provider may not be offered if that one type of provider does not service a region that is geographically accessible by the woman.

Some embodiments further contain a fifth element, a pricing algorithm. This algorithm is electronically in communication with the resulting list of services and the data from the contracted vendors. The pricing algorithm is configured to provide a single fee for a packaged bundle including the selected bundle of services. Fees may vary for a number of reasons. Often fees will vary between midwife directed services and medical doctor directed services because their hourly rates often differ. The former may practice in less expensive independent birthing centers while the latter practices in more expensive facilities such as hospitals or hospitals with attached birthing centers. In addition, fees may vary for services of vendors from one geographical region to another.

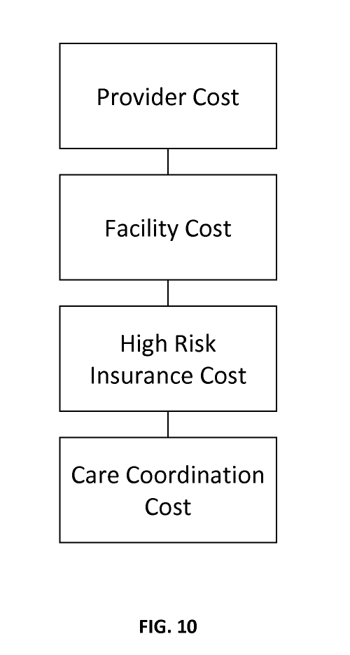

A packaged bundle of services has a single fee for the term of the perinatal care. FIG. 10 is a block diagram that shows the contents of a packaged bundle of services. As seen, it contains a high-risk insurance cost and a coordination cost in addition to the contracted costs of provider and facility. The high-risk insurer is a business entity able to contractually offer insurance for the cost of high-risk service occurrences during perinatal care that were not foreseen during verification of the initial risk score assessment as low risk. This high-risk insurance element permits the offer of a single packaged fee that will not change even if the pregnancy risk of a woman may change later from low to high. The coordinator is the entity that obtains contracts with vendors and provides a personalized coordinated perinatal care system to a pregnant woman.

Contracted fees may have less variation within the same geographical region. The size of this region may vary across the United States but is generally at least the size of a county. In some embodiments, this stability permits a single packaged fee to be offered to all women having an initial pregnancy risk of low that are living within the same geographical region and choose packaged bundles having the same type of provider. This fee is generally the same for the terms stated in the contracts with vendors. In some embodiments, the time span is a calendar year regardless of when the contract was signed. In some embodiments, the offered fee will remain constant for a month. In some embodiments, the time span may be something other than what has been previously stated based on such things as, for example, individual vendor contract terms and government regulations.

In some embodiments for a woman having a pregnancy category of low risk, the matching algorithm of element four may also be configured to assemble more than one packaged fee. For reasons mentioned above, fees for bundles that contain care by a medical doctor would likely differ from the fees of bundles that contain care by a midwife. These fees would be considered offers that could only be considered to be accepted by the woman after the initial low-risk category was verified during the examination and she affirmatively accepts a single packaged bundle as discussed above.

Embodiments of the system of the invention may further include a sixth and seventh element. The sixth element is a database with verification data about the initial risk category. The sixth element is the affirmative selection of a bundle of services by the woman. The seventh element is a pricing algorithm configured to provide a single fee for a packaged bundle of services containing the selected bundle of services. These elements result in a single fee for a packaged bundle of services.

The sixth element is a database with verification data about the initial risk category. This database contains verified data from the initial questionnaire completed by the woman. The original data may be erroneous due to misunderstanding or deception, intentional or otherwise, by the one completing the questionnaire. Thus, the questionnaire data must be verified before a single fee can be discussed. The woman is to select a provider from her recommended bundle of services and have an initial exam. The exam is to determine that the questionnaire answers are both substantially correct and any omissions are insignificant. The initial risk determination is then considered verified and the provider conducting the exam so indicates on the database containing data about the woman's personal situation. If answers are not substantially correct or significant omissions have been made, the questionnaire is corrected and resubmitted. Then the resulting risk category is considered verified as the examining provider so indicates in the database.

The seventh element is a database containing the affirmative selection of a bundle of services by the woman. In this embodiment, low-risk women generally have a choice of at least two bundles of services, the first includes care directed by a medical doctor and the second includes care directed by a midwife. Once the woman is confirmed to have a pregnancy category of low risk, she is able to select one bundle of services on an affirmative manner. Since fees likely vary between these two types of services even within the same geographical region, the woman must affirmatively select one type to contractually accept the offered fee. Once the bundle has been affirmatively selected, a single fee is assigned to a packaged bundle of services.

Embodiments of the system of the invention may still further include an eighth and ninth element. The eighth element is a coordinator. The ninth is a contractual arrangement with the coordinator and at least one payer.

The eighth element is a coordinator. The coordinator is able to interact with the contracted vendors as part of the packaged bundle of services for a single fee. In that capacity, the coordinator disperses the contracted payments to all vendors under contract on a bundled list of perinatal care services chosen by a pregnant woman. The coordinator is also able to alter services as the need arises through a change in the woman's personal situation. Some changes may be with the services provided by a vendor. Other changes may require a change of vendors, such as, for example, when a woman of initially low risk develops one or more high-risk factors that need more specialized perinatal care than available from all the vendors of an initial bundle of services. These changes are provided in a substantially seamless manner for the pregnant woman at no additional cost.

The ninth element is a contractual arrangement with the coordinator and at least one payer. The arrangement is to pay a single fee within a geographical region for the pregnancy care of a woman selecting a bundled list of perinatal services and having a verified risk category of low. This arrangement drives the vendors to be more efficient in providing services by minimizing unnecessary testing and unproductive interventions and procedures. Payers can see more fee stability in obtaining high-quality pregnancy care for a majority of women and their babies.

The vendors are under contract. At the least, they have agreed to perform the services that are associated in the database with that vendor. In some embodiments, particularly for pregnancies initially categorized as low risk, the vendors have further listed the geographical region within at least a county that they service. In some embodiments, particularly for pregnancies initially categorized as low risk, they have agreed to accept one fee for the entire perinatal care of the woman and her baby. This fee would be prorated if the woman were to change her care during the pregnancy to another vendor.

### Method

The second aspect of my perinatal care invention is the method. In its broadest perspective, the method includes six steps. It applies to pregnant women having any pregnancy risk categorizations.

The first step is of compiling service data. In this step, a comprehensive list of pregnancy care services is provided in a database. The services are those that are associated with pregnancy factors related to the various types and risks commonly known to occur during pregnancy cycle from conception to post-delivery. In this step, a list of contracted vendors that have agreed to provide the services is also provided. That list also includes the geographical region within which the vendor provides such services.

The second step is of providing a comprehensive questionnaire about a pregnant woman's personal situation to be completed. The questionnaire includes sections about her obstetric history, current life style, pregnancy care preferences, and medical issues that may affect her pregnancy.

The third step is of receiving the completed questionnaire and entering the data in to a database. Typically, the woman is the one completing the questionnaire; however, the woman may use an agent to actually complete the questionnaire on her behalf and under her direction. The questionnaire is generally in communication with the database so that the data entered for the woman is also entered into the database.

The fourth step is of applying a comprehensive perinatal risk scoring and selection algorithm to the personal situation data to determine at least an initial risk category. The first part of this step determines at least a first risk category based on the woman's personal situation. The second part of this step assembles at least one comprehensive list of pregnancy care services based on the woman's personal situation.

The fifth step is of assembling at least one bundled list of perinatal care services and contracted vendors. The list of services is comprehensive and covers all that would be selected for the woman based on information at hand. The contracted vendors comprise those that have agreed to perform the services and who most closely match her personal situation regarding her pregnancy.

The sixth step is of providing the woman with at least one bundled list. In cases where a woman is low risk, some embodiments may provide a bundle including a medical doctor provider and a bundle including a midwife provider. Some embodiments may also provide a packaged bundle with a single fee for the entire pregnancy.

Another embodiment of the method invention also includes the offering and accepting of a single fee for the bundle of services. This embodiment only applies to women having a pregnancy category of low risk.

The seventh step is of observing that the pregnant woman has a pregnancy risk category of low risk. This is done by the matching algorithm. The database containing vendor data also contains pricing data. This algorithm is also configured to provide single fees for packages of services that most closely match the woman's personal situation.

The eighth step is of conditionally offering the woman at least a single-packaged fee for at least one bundle of services if low-risk categorization is verified. A low-risk category woman will be offered at least one packaged bundle that most closely matches her personal situation. Fees generally vary between packaged bundles that contain a medical doctor and packaged bundles that contain a midwife. Both types will typically be offered unless the woman has expressed a strong preference for one particular type.

The ninth step is of conditionally accepting one bundle by the woman. This is a tentative acceptance by the woman of the packaged bundle of services with the offered fee. Actual acceptance requires verification of the low-risk categorization.

The tenth step is of verifying the categorization. If the woman has an initial pregnancy of low risk, she must be examined by a provider from the bundled list of services she is interested in to verify that the initial category of low risk is true. This is done as described above.

The eleventh step is of confirming the contract. Once the low-risk categorization is verified, the agreement to receive a packaged bundle of services for a single fee is set.

The fee will not change even if the woman experiences some high-risk factors during the pregnancy that result in a change of services.

In some embodiments, at least one contracted vendor provides detailed information about his or her service philosophy regarding pregnancy. In these embodiments, at least one bundle of services will contain vendors that have a philosophy most consistent with the woman's personal situation.

In addition, in some embodiments, the single fee is conditionally offered to all women. This offering is generally restricted to those within the same geographical region and the region is generally at least the size of a county.

Further, in some embodiments where the verified pregnancy category is low risk, the single packaged fee is the same for all women with certain conditions. The offered fee is the same within a region at least the size of a county or its equivalent at the time the offer is made.

Some embodiments of my method further include repeating the assessment phase to monitor any changes in a woman's personal situation. These embodiments involve a twelfth and thirteenth step.

The twelfth step is of repeating the second, third, and fourth steps previously discussed. This is to determine if changes have occurred that suggest or dictate a change in the perinatal care. This repetition can be at the instigation of the provider, the woman, or another. The repetition may be for an isolated time or as a periodic operation such as, for example, monthly, quarterly, or some other sequence suggested by the provider, woman, or other.

The thirteenth step is of adjusting the bundle of services accordingly. This adjustment is to accommodate the changes in the woman's personal situation to provide satisfactory perinatal care. This occurs at no additional change in packaged fee.

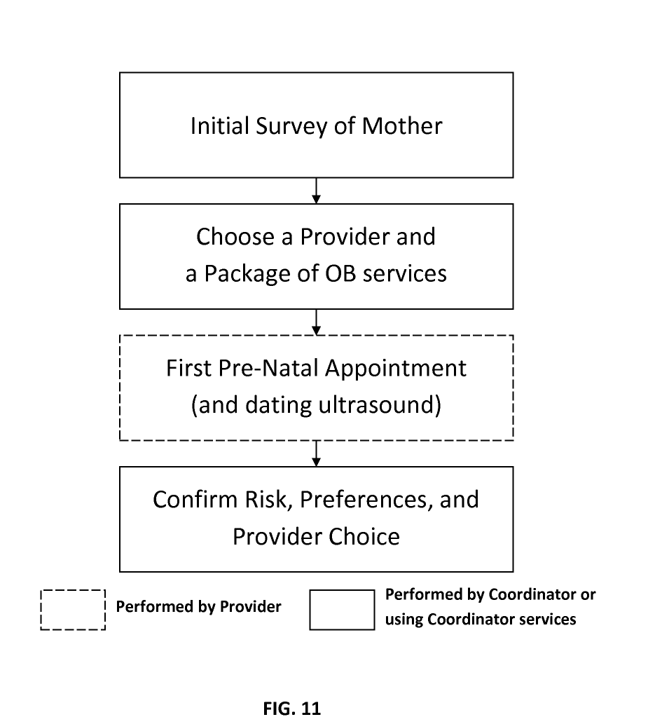

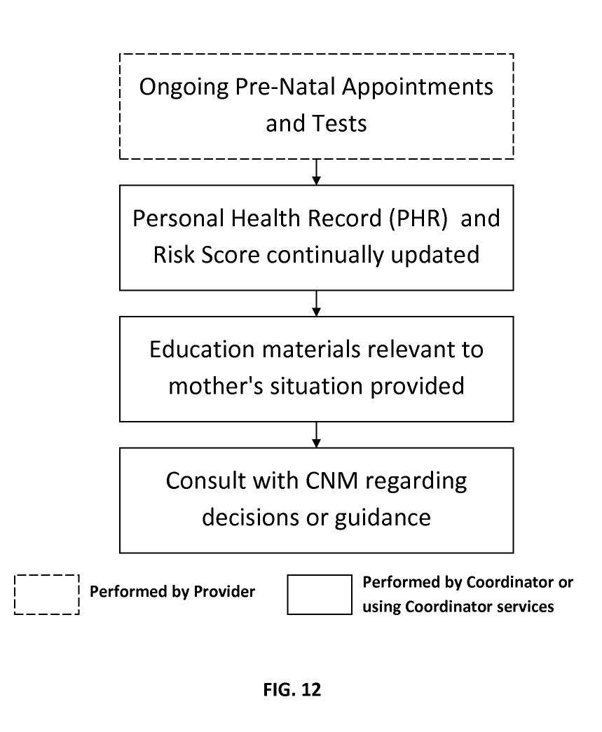

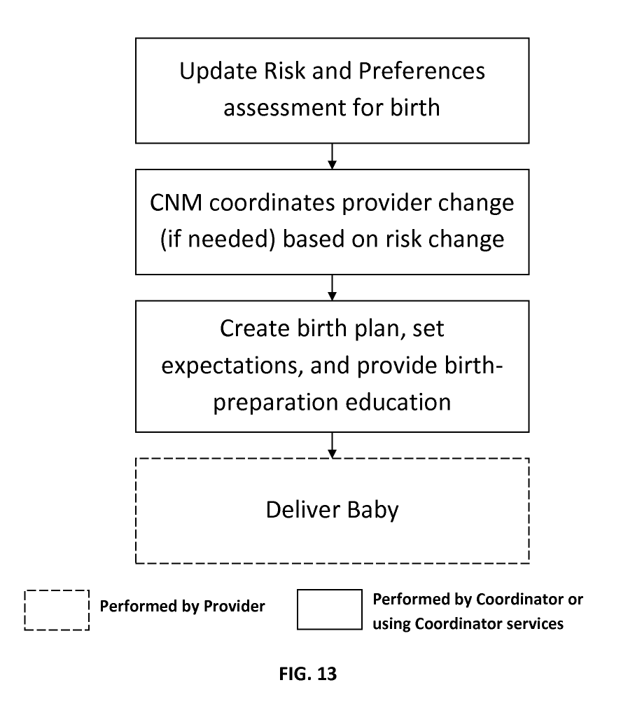

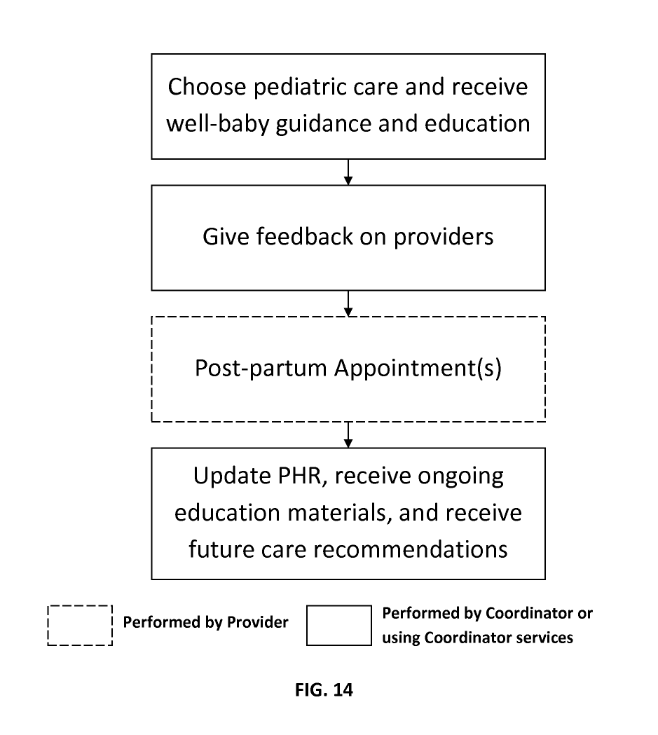

Another way to view the method aspect of my invention is to show how an embodiment of my invention inserts process steps into a perinatal care regimen. FIGS. 11-14 depict an embodiment of the process of my invention during the four phases of perinatal care. FIG. 11, FIG. 12, FIG. 13, and FIG. 14 are block diagrams of the new pregnancy care phase, the pre-natal care phase, the birth preparation and delivery care phase, and post-partum and baby care phase, respectively. In each figure, the service in the dotted-lined box is a process step that the woman experiences with current systems and the service in the solid-lined box is a process step that is only provided by the method of my invention. As, seen, the perinatal care method of this embodiment of my invention is significantly influenced by the mother's personal situation and her participation.

### Apparatus

The third aspect of my perinatal care invention is the apparatus. In its broadest perspective, it is an apparatus for providing personalized coordinated perinatal care for a woman and her baby that contains four elements. The first is a server having a database comprising perinatal care service information and information provided by a pregnant woman. The second is a server having a risk scoring and selection algorithm that evaluates her pregnancy risk. The third is a server having a database comprising contracted vendor information. The fourth is a server having a matching algorithm that results in a bundled list of services for the woman.

The first element is a server having a database comprising perinatal care service information and information provided by a pregnant woman. The server is in communication with the internet. The database contains a comprehensive list of perinatal care services and data from at least one completed questionnaire about a woman's personal situation. The personal situation data includes her obstetric history, current life style, pregnancy care preferences, and medical issues that may affect her pregnancy.

The second element is a server having a risk scoring and selection algorithm that evaluates her pregnancy risk. The algorithm is in communication with data from the completed woman's questionnaire and is configured to determine a pregnancy risk category. It is also in communication with the list of services and is configured to assemble a comprehensive list of services based on the woman's personal situation

The third element is a server having a database comprising contracted vendor information. The database includes a list of contracted vendors who have at least agreed to perform the list of perinatal services. It also includes the geographical region that each vender serves.

The fourth element is a server having a matching algorithm that results in a bundled list of services for the woman. The algorithm is in communication with the completed woman's questionnaire and the list of contracted vendors. It is configured to match the comprehensive list of services that most closely match the woman's personal situation with the contracted vendors that have agreed to perform them to generate at least one bundled list containing both the services and contracted vendors able to perform the services. More than one server may be the same server.

Some embodiments of the apparatus invention include a vendor database that also includes at least one vendor being associated with completed detailed vendor questionnaire. The questionnaire contains data about the vendor's philosophy regarding perinatal care. The matching algorithm is further configured to match the vendor philosophy with the woman's personal situation.

In addition, some embodiments further include two elements that provide a packaged fee for bundles of services for some women. The first element is a server that includes a database that has cost information sufficient to create a fee for a packaged bundle of services for a low-risk pregnancy. The second element is a server that contains a calculating algorithm that is in communication with the list of bundled services, the cost information, and the risk category. The algorithm is configured to provide a single packaged fee for the bundle of services within a geographical region that are associated with a risk category of low risk.

The technology used by my invention is readily available to create the databases mentioned above and can be assembled in a variety of ways. Space on servers with internet connections can be rented or purchased to create the above specified databases. Also, suppliers of data manipulation services can be used to create the databases and arrange lists with the above described algorithms. The algorithms can be easily developed by people with ordinary programming skills. My invention, in its various aspects, is a recognition of a need in perinatal care and the use of a combination of known or readily created elements in an unknown but useful and desired manner to create needed improvements in the perinatal care systems, methods, and apparatuses over the systems, methods and apparatuses that are currently known.

Other modifications and changes regarding my perinatal care invention will be apparent to those skilled in the art. The invention is not considered limited to the embodiments chosen for purposes of disclosure and covers all changes and modifications which do not constitute departures from the true spirit and scope of this invention.

I claim:

1. A system able to provide personalized, coordinated perinatal care for a woman and her baby, comprising:
an electronic database on an internet-connected server comprising a comprehensive list of perinatal care services and data from at least a first completed questionnaire about a woman's personal situation related to her pregnancy from a group comprising her obstetric history, current life style, pregnancy care preferences and medical issues that may affect her pregnancy;
a comprehensive perinatal risk-scoring and selection algorithm in electronic communication with data from each questionnaire that is configured to both assign at least an initial perinatal care risk category to the completed questionnaire and assemble a comprehensive list of services based on the woman's personal situation;
an electronic database on an internet-connected server comprising a list of contracted vendors who have agreed to perform the perinatal care services; and
a matching algorithm in electronic communication with the databases and the risk-scoring and selection algorithm that is configured to both match the comprehensive list of recommended services with the contracted vendors that have agreed to perform them and generate at least one bundled list containing both the services and contracted vendors able to perform the services.

2. The system of claim 1, wherein vendors comprise facilities, providers, and payers.

3. The system of claim 1 wherein the vendor database further comprises a completed detailed questionnaire about vendor perinatal care service philosophy for at least one contracted vendor and the matching algorithm is also configured to consider vendor philosophy when matching services that most match a woman's personal situation with contracted vendors to generate a bundled list containing the comprehensive list of services and list of contracted vendors both able to perform the services and who are most compatible with the woman's personal situation.

4. The system of claim 1, wherein the electronic database containing lists of perinatal care services and contracted vendors also contains the locations serviced by the vendors.

5. The system of claim 4 wherein the matching algorithm is further configured to match the comprehensive list of services with the contracted vendors that are also geographically accessible to the woman.

6. The system of claim 2 wherein the perinatal care risk category is selected from a group consisting of a low risk category and a high risk category, the contracted vendors have further contractually agreed to perform the services for low-risk categorized women for a single comprehensive fee, and the matching algorithm is also configured to generate for each woman of the low-risk category at least one bundle from a group consisting of a bundled list of services that includes a medical doctor as primary care provider and a bundled list of services that includes a midwife as primary care provider.

7. The system of claim 6, further comprising:
a pricing algorithm configured to generate for a low-risk category a single packaged fee within a geographical region for each bundle that initially includes the medical doctor as primary care provider and a single packaged fee within a geographical region for each bundle that initially includes the midwife as primary care provider.

8. The system of claim 7, further comprising:
a database containing a verification of the initial perinatal care risk category determined by an exam with a provider of one of the services on the bundled list and a determination that the questionnaire answers are both substantially correct and any omissions are insignificant, and
a database containing a selection by the woman verified to be in the low-risk category of a specific perinatal care service bundle.

9. The system of claim 8 further comprising:
a coordinator able to interact with the vendors of a bundle of services having a single comprehensive fee to disperse contracted payments to all vendors under contract on a bundled list of perinatal care services chosen by a woman and
a contractual arrangement between the coordinator and at least one payer to pay a single packaged fee within a geographical region for the woman selecting a bundled list of perinatal services and having a verified risk category of low.

10. The system of claim 6, further comprising:
a pricing algorithm configured to generate for low-risk categorized women within a geographical region for a specified period of time a same single packaged fee for all bundles that initially include the medical doctor as primary care provider and a same single packaged fee within a geographical region for all bundles that initially include the midwife as primary care provider.

11. The system of claim 10, further comprising:
a coordinator able to interact with the vendors of a bundle of services having a single comprehensive fee to disperse contracted payments to all vendors under contract on a bundled list of perinatal services chosen by a woman and
a contractual arrangement between the coordinator and at least one provider to pay the single packaged fee within a geographical region associated with the verified first risk category for the woman selecting a bundled list of perinatal services.

12. The system of claim 1 wherein questionnaires completed by the woman or the provider for the woman are more than one and they are spaced over time during pregnancy to determine noteworthy changes in a woman's personal situation that may alter the composition of the initial list of bundled care services.

13. A method for providing personalized coordinated perinatal care for a woman and her baby, comprising the steps of:
(a) compiling in a database a comprehensive list of perinatal care services and a list of contracted vendors that perform the perinatal care services within geographical regions,
(b) providing a detailed questionnaire about a woman's personal situation comprising her obstetric history, current life style, pregnancy care preferences, and medical issues that may affect her pregnancy,
(c) receiving the completed questionnaire from the woman and entering the data into a database,
(d) applying a comprehensive perinatal risk-scoring and selection algorithm to the data from the completed questionnaire to determine at least an initial risk category for her pregnancy based on the woman's personal situation and to assemble at least one comprehensive list of services based on the woman's personal situation,
(e) assembling at least one bundled list of perinatal care services most closely matching her personal situation regarding her pregnancy that comprises the comprehensive list and the contracted vendors able to perform the services, and
(f) providing a woman with at least one bundled list.

14. The method of claim 13, further comprising the steps of:
(g) observing that the woman has a pregnancy category of low risk,
(h) conditionally offering the woman at least one single packaged fee for at least one bundle of services,
(i) conditionally accepting of one bundle by the woman,
(j) verifying the first risk category is low risk by having the woman be examined by a contracted vendor from the selected bundle, and
(k) confirming to contract for the packaged bundle of services at the offered fee.

15. The method of claim 13 wherein at least one contracted vendor provides detailed information about their service philosophy regarding pregnancy and at least one bundled list comprises vendors that have a philosophy most consistent with the woman's personal situation.

16. The method of claim 13 wherein the single packaged fee within a region that is at least the size of a county comprises a first single packaged fee that is the same for all women with a bundle that includes the services of a medical doctor as primary care provider and a second single packaged fee that is the same for all women with a bundle that includes the services of a midwife as primary care provider.

17. The method of claim 14, further comprising the steps of:
(l) repeating steps (b) to (d) for the woman to determine if changes have occurred that dictate a change in perinatal care, and
(m) adjusting the bundle of services to accommodate the changes to provide satisfactory perinatal care at no additional change in packaged fee.

18. An apparatus for providing personalized coordinated perinatal care for a woman and her baby, comprising:
a server in communication with the internet and having a database with a comprehensive list of perinatal care services and data from at least one completed questionnaire about a woman's personal situation comprising her obstetric history, current life style, pregnancy care preferences, and medical issues that may affect her pregnancy;
a server having a risk scoring and selection algorithm in communication with data from the completed questionnaire and configured to determine a pregnancy risk category and assemble a comprehensive list of services based on the woman's personal situation;
a server having a database comprising a list of contracted vendors who have at least agreed to perform the services associated with a geographical region; and
a server having a matching algorithm in communication with the databases and configured to match the comprehensive list of services that most closely match the woman's personal situation with the contracted vendors that have agreed to perform them to generate at least one bundled list containing both the services and the contracted vendors able to perform the services,
wherein more than one server may be the same server.

19. The apparatus of claim 18 wherein at least one vendor in the list of contracted vendors is associated with a completed detailed vendor questionnaire that contains data about the vendor's philosophy regarding perinatal care and the matching algorithm is further configured to match the vendor philosophy with the woman's personal situation.

20. The apparatus of claim 19, further comprising:
a server comprising a database that has cost information sufficient to create a fee for a packaged bundle of services for a low-risk pregnancy, and
a server containing a calculating algorithm in communication with the list of bundled services, the cost information, and the risk category, and configured to provide a single packaged fee for the bundle of services within a geographical region that are associated with a risk category of low risk.
